(19) United States
(12) Patent Application Publication
(10) Pub. No.: US 2003/0046131 A1
(43) Pub. Date: Mar. 6, 2003

(54) Method of selecting media for a print job

(76) Inventor: Robert K. Holzwarth, Palmyra, NY (US)

Correspondence Address: BRINKS HOFER GILSON & LIONE, P. O. Box 10395, Chicago, IL, 60610-0395, US

(21) Appl. No.: 10/236,686

(22) Filed: Sep. 5, 2002

Related U.S. Application Data
(60) Provisional application No. 60/317,698, filed on Sep. 5, 2001.

(51) Int. Cl. G06F 17/60

(52) U.S. Cl. 705/7

(57) ABSTRACT

A method of selecting media for a print job on a document production system. The method includes creating a reduced paper catalog from a complete paper catalog. Each available media in the complete paper catalog and the reduced paper catalog is associated with the attributes for the available media. The reduced paper catalog includes less available media compared to the complete paper catalog. The method also includes selecting the media for the print job from the reduced paper catalog.

### CROSS REFERENCE TO RELATED APPLICATIONS

This application is based on Provisional Application 60/317,698 having the title “A Method of Selecting Media for a Print Job” filed on Sep. 5, 2001. The benefit of the filing date of the Provisional Application is claimed for this application.

### FIELD OF THE INVENTION

This invention relates to digital printing systems. More particularly, the invention relates to a method for selecting media for a print job in a printing system.

### BACKGROUND

A digital printing system may include a paper catalog for selecting output media to be used in a print job. The paper catalog is a list whose entries may correspond to every physical stock of media that is available in a print shop and is available for selection by a user at the printing system or a user at a remote processing system. The entry for a selected media in the paper catalog includes an identifier for the media, such as a paper name, and its respective attributes, such as size, weight and type. Each print shop may require its own specific list corresponding to all media available in the print shop.

An advantage of using the paper catalog is that the attributes of each media are stored as entries in the paper catalog and need not be entered each time a media is selected for printing. By having the attributes associated with a name for the media in the paper catalog, the user need only make a single selection from the paper catalog to define media rather than making a selection for each attribute of the media. Selecting each attribute for the media typically entails, for each attribute, selecting a value for the attribute from a list of all possible values for the attribute. This selection process would then be repeated for each attribute.

Often, however, the complete paper catalog may contain entries for many types of media available in the print shop. In a professional print shop, the number of different types of available media may easily exceed one hundred. In this case, selection of one media from the complete paper catalog may be cumbersome, even if it is easier than selecting each of the attributes of the medium separately. Therefore, there is a need to provide an improved method for selecting media for a print job.

### SUMMARY

In order to overcome the deficiencies in the prior art, an improved method and system are provided for selecting media for a print job. In accordance with one aspect of the invention, a method of selecting media for a print job on a user interface of a document production system includes displaying a graphical representation of a plurality of media entries from a paper catalog on the user interface. The paper catalog corresponds to the media available in the printshop. The method also includes recognizing that a media entry has been selected from the plurality of media entries on the user interface, and adding the selected media entry to a reduced paper catalog. The reduced paper catalog corresponds to the media used in the print job.

Another aspect of the invention is a method of selecting media for a print job on a document production system that includes creating a reduced paper catalog from a paper catalog, and selecting the media for the print job from the reduced paper catalog.

Yet another aspect of the invention is a system for selecting media for a print job on a user interface of a document production system. The system includes means for displaying a graphical representation of a plurality of media entries from a paper catalog on the user interface. The paper catalog corresponds to the media available in the print shop. The system also includes means for recognizing that a media entry has been selected from the plurality of media entries on the user interface. The system further includes means for adding the selected media entry to a reduced paper catalog. The reduced paper catalog corresponds to the media used in the print job.

The foregoing and other features and advantages of preferred embodiments of the present invention will be more readily apparent from the following detailed description, which proceeds with reference to the accompanying drawings.

### BRIEF DESCRIPTION OF THE DRAWINGS

FIG. 1 is a block diagram of a preferred document production system;

FIG. 2 is a diagram of a printing system with multiple input sources and output destinations;

FIG. 3 is an illustrative screen associated with a user interface of the document production system of FIG. 1 for making a print job request;

FIG. 4 is an illustrative screen associated with a user interface for showing a paper catalog;

FIG. 5 is another illustrative screen associated with a user interface of the document production system of FIG. 1 for showing a paper catalog; and

FIG. 6 is a flow diagram illustrating a preferred method of selecting media for a print job on a user interface of document production system of FIG. 1.

### DETAILED DESCRIPTION OF THE PRESENTLY PREFERRED EMBODIMENTS

As used herein, a printing system shall refer to a digital printing system, a duplicating system, or both. This invention relates to a printing system that has at least one input source and preferably multiple input sources and at least one output destination. Further, where multiple input sources are present, each of the input sources may be loaded with different media (e.g., different types or sizes of paper). The printing system 26 may be capable of producing collated output sets of sheets, which are deposited in one or more of the output destinations.

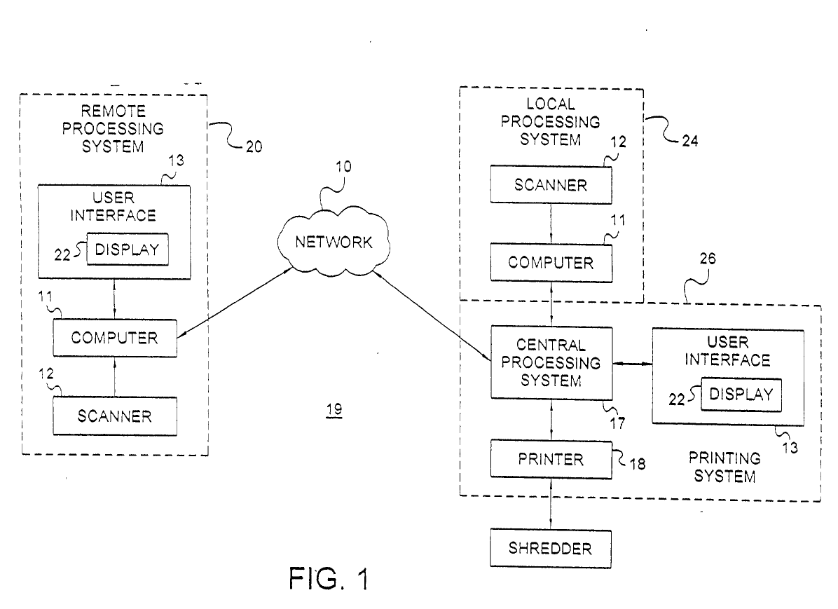

In accordance with the invention, FIG. 1 shows a block diagram of a document production system 19. The document production system 19 includes a remote processing system 20, a communications network 10, a local processing system 24, and a printing system 26. The remote processing system 20 may communicate with the printing system 26 over the communications network 10. The local processing system 24 may communicate directly with the printing system 26.

The document production system 19 facilitates the conversion of a physical representation (e.g., printed page) of an input image to an electronic representation at the local processing system 24 or at the remote processing system 20. The document production system 19 facilitates the transfer of an electronic representation of one or more input images from a remote processing system 20 to the printing system 26 over the communications network 10. The printing system 26 processes the electronic representation in a manner that supports page-by-page routing of output pages to one or more output destinations of the printer 18.

The remote processing system 20 includes a user interface 13 coupled to a computer 11. In turn, the computer 11 is coupled to a scanner 12. In one embodiment, the user interface 13 refers to a graphical user interface that includes a keyboard, a pointing device (e.g., mouse), a display 22, and attendant software instructions to support the keyboard, the pointing device, and the display 22. The computer 11 may represent a source or receptor of one or more print jobs for the printing system 26. For example, the computer 11 may support a print job derived from the operation of the scanner 12. The computer 11 may transmit the print jobs, including electronic representations of input images or documents, to the printing system 26 via the communications network 10. The communications network 10 may refer to the Internet, an intranet, a circuit-switched network, a data packet network, an ethernet system, or any other suitable communications network.

The local processing system 24 includes a scanner 12 coupled to a computer 11. In turn, the computer 11 manages communications with a central processing unit (“CPU”) 17 of the printing system 26. The local processing system 24 may represent a source or receptor of one or more print jobs to the printing system 26.

The remote processing system 20 or the local processing system 24 can create electronic representations of input pages for execution by the printing system 26. The scanner 12 supports scanning of input images on pages and producing an electronic representation of the input images for printing on the printing system 26.

The printing system 26 includes a CPU 17 that is coupled to a user interface 13 and a printer 18. The user interface 13 includes a display 22. The CPU 17 refers to a computer or data processing system, which accepts print jobs via the communications network 10 or otherwise. For example, the print jobs may come from the remote processing system 20, the local processing system 24, or both.

The CPU 17 controls many or all aspects of printing one or more print jobs on the printer 18. The CPU 17 may be physically implemented using one or more data processors, in a conventional or parallel computing architecture to control the printing process. The CPU 17 may determine a pattern of media feeds for each output set of a print job to achieve a desired appearance characteristic of sheets of an output set. The desired appearance characteristic may include scaling of an image, resolution of an image, contrast of an image, darkness or intensity of an image, the order of sheets in an output set, the selection of media for different sheets in an output set, stapling of sheets in an output set, binding of an output set, holes in media of the output set, or other attributes that affect the visual appearance or presentation of a print job.

The printing system 26 may maintain data bits at memory locations in its respective memory systems to reconfigure or otherwise alter the CPU's 17 operation, as well as other processing of signals. The memory locations, such as random access memory (“RAM”), are physical locations that have particular electrical, magnetic, or optical properties corresponding to the data bits, depending on the type of memory used. The local processing system 24 and remote processing system 20 also include respective central processing units (not shown) in their computers 11, and also include respective memory systems (not shown).

The data bits may also be maintained on a computer readable medium including magnetic disks, optical disks, and any other volatile or nonvolatile mass storage system readable by the CPU 17 of the printing system 26 or by the computers 11 within the local processing system 24 and remote processing system 20. The computer readable medium includes cooperating or interconnected computer readable media that exist exclusively on the printing system 26 or are distributed among multiple interconnected processing systems such as the local processing system 24 or the remote processing system 20.

The user interface 13 supports a user's selection of features of the printing system 26 or preferences in the ultimate presentation of the output set or print job produced by the printing system 26. Upon receiving a print job at the CPU 17, a user of the printing system 26 uses the user interface 13 to check the status of the print job or jobs. Further, the user may use the user interface 13 to determine how the print jobs are set up. The display 22 of the user interface 13 may have separate screens dedicated to corresponding functions such as displaying the status of the print job and structuring the setup of the print jobs. A screen represents an image that is displayed on the display 22 of the user interface 13.

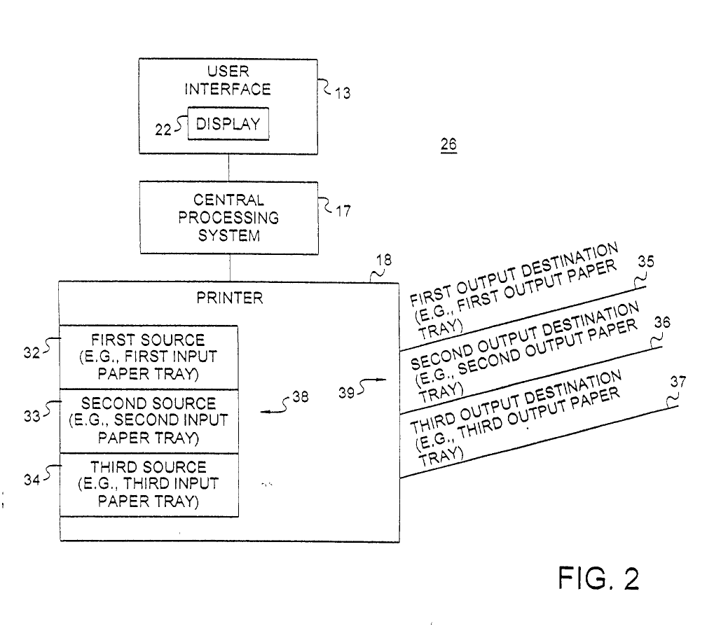

An additional screen allows the operator to view the attributes of the media loaded in the input sources, which are shown in FIG. 2. Another additional screen provides the display of jam recovery instructions so that the user is notified of jam recovery instructions or instantaneous feedback on corrective measures that the user has applied to the printer 18.

FIG. 2 is a block diagram of a printing system 26 which has multiple input sources 38 and multiple output destinations 39. Like reference numbers in FIG. 1 and FIG. 2 indicate like elements. Although three input sources 38 and three output destinations 39 are shown, in other embodiments that fall within the scope of the invention, the printing system 26 may have as few as one input source and one output source. As shown in FIG. 2, the input sources 38 include a first input source 32, a second input source 33, and a third input source 34. The output destinations 39 include a first output destination 35, a second output destination 36, and a third output destination 37.

The input sources 38 may represent several different alternative structures. In accordance with a first alternative, the input sources 38 may include print trays for holding an assortment of different types of media (e.g., paper). When the printer 18 is in operation, the media in the print trays passes through the printer 18 and may receive an image that is printed by a print engine (not shown). In accordance with a second alternative, the input sources 38 may include inserters that hold another assortment of different types of media for passage through the printer 18 without printing on them. Media from the inserters may take an alternate paper path through the printer 18 that does not go through the print engine. Examples of inserted media include media that do not require an image from the printer 18, such as completed photographic inserts, ordered media (e.g., tabs) and section dividers.

The output destinations 39 may represent several different alternative structures. In accordance with a first alternative, the output destinations 39 may be trays for holding assortments of different types of media. In accordance with a second alternative, the output destinations 39 may represent different finishing devices for application to one or more pages after the printing or the passage of the pages through the printer 18 without printing on them. Finishing devices may include a stapler, a stacker, a folder, a binder, or another processing station for processing media sent to the output destination. For example, the first output destination 35 may be associated with a stapler that staples groups of paper, the second output destination 36 may be associated with a stacker that stacks paper in sequential order, and the third output destination 37 may be associated with a folder that folds paper to facilitate selective processing of the output pages of an output set of a print job.

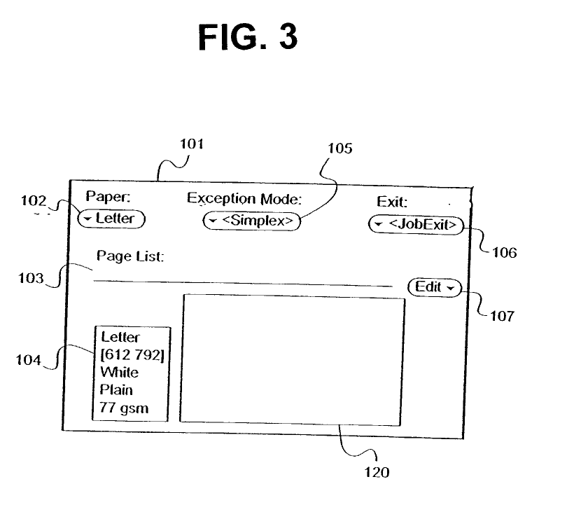

FIG. 3 is an illustration of a screen that may be displayed on the user interface 13 of the remote processing system 20, the printing system 26, or both. The screen is an image on the display 22 that supports user interaction with the printing system 26. A screen may be displayed on the display 22 to enable a user to control various aspects of the printing system 26.

The screen 101 of FIG. 3 includes a medium indicator 102 (e.g., “Paper”), an exception mode 105, an output destination indicator 106 (e.g., “Exit”), and an editing indicator 107 (e.g., “Edit”). The operational parameters of the medium indicator 102, the exception mode 105, the output destination indicator 106, and the editing indicator 107 may be selected from pull-down menus. A user may reveal a pull-down menu by operation of the pointing device of the user interface 13 or otherwise. Alternatively, the medium indicator 102, the exception mode 105, the output destination indicator 106 and/or the editing indicator 107 may appear as text windows simultaneously displaying a selected list of operation parameters to the user in place of pull-down menus.

In one example, the user may select a media for the pages to be printed by using the pull-down menu associated with the medium indicator 102. For the media selection indicated by media indicator 102 (e.g., “Paper”), the respective attributes are shown in a text box 104. In a preferred embodiment of the present invention, the user selects the media from a paper catalog. The paper catalog is a list whose entries may correspond to every physical stock of media that is available to the user in the print shop and which may be loaded on the printer 18. The entry for a selected media in the paper catalog includes an identifier for the media and its respective attributes. Each print shop may require its own specific list corresponding to the stock available in the print shop. The paper catalog is more fully described below.

It should be understood, however, that the screen 101 of FIG. 3 is for illustrative purposes only and that the user interface 13 of the present invention is not restricted to the screen depicted in FIG. 3. The user interface 13 may display other arrangements of the screens, which may contain more or fewer indicators. Additionally, the user interface 13 may present multiple screens in place of the single screen as illustrated in FIG. 3. The multiple screens may enable the user to control various aspects of the printing system 26.

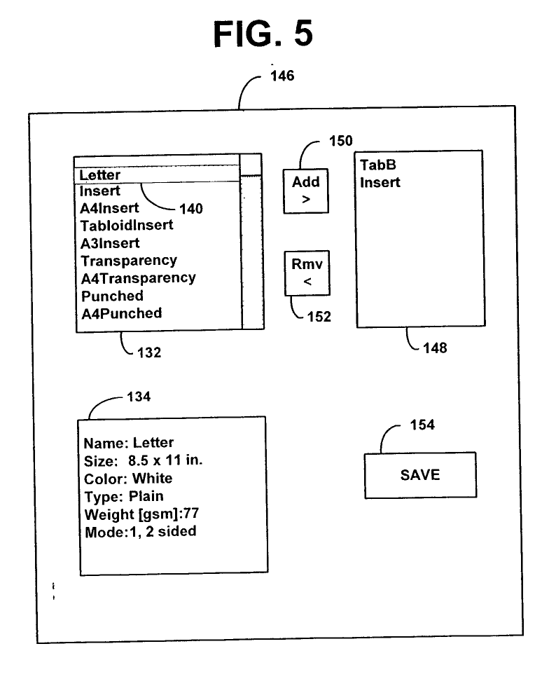

As described above, the user may select a media for the pages to be printed using the pull-down menu associated with the medium indicator 102 of FIG. 5. In a presently preferred embodiment, the user selects the media from a paper catalog. The paper catalog is a list whose entries may correspond to every physical stock of media that is available to the user in the print shop. The entry for a selected media in the paper catalog includes an identifier for the media, such as a paper name, and its respective attributes. Each print shop may require its own specific list corresponding to all stock available in the print shop.

An advantage of using the paper catalog is that the attributes of each media are stored as entries in the paper catalog. Therefore the attributes do not need to be entered each time a media is selected for printing. Some printing systems require that when the user is creating the page list 103 for each media in the print job, the user must define each attribute of the media separately, i.e., enter each of the size, color, weight, type and/or mode separately. In contrast, by having the attributes associated with a name for the media in the paper catalog, the user need only make a single selection from the paper catalog to define media rather than making a selection for each attribute of the media.

The print shop changes the paper catalogue when a new media is added to the paper stock. Typically, the print shop uses a utility program to edit the paper catalog, enter a name for the new media, and enter the attributes of the new media. The utility program stores the entry for the new media in the paper catalog. Also, should the print shop discontinue stocking a media or substitute a media for another with different physical properties, the utility program may delete the entry for the media from the paper catalog or provide a dialog for changing the attributes of the media entry to conform to the different physical properties.

In one presently preferred embodiment, the user interface presents the paper catalog to the user as a pull-down menu associated with the medium indicator 102. The pull-down menu is a graphical representation that may include the names of all media in the paper catalog. When the user selects the media from the pull-down menu, the medium indicator 102 displays the name of the selected media and the text box 104 displays the attributes of the named media that have been stored in entry for the media in the paper catalog.

Often, however, the paper catalog may contain entries for many types of media available in the print shop. In a professional print shop, the number of different types of available media may exceed one hundred. In this case, the use of the pull-down menu would be cumbersome. In another presently preferred embodiment, the print catalog is presented as another screen on the user interface.

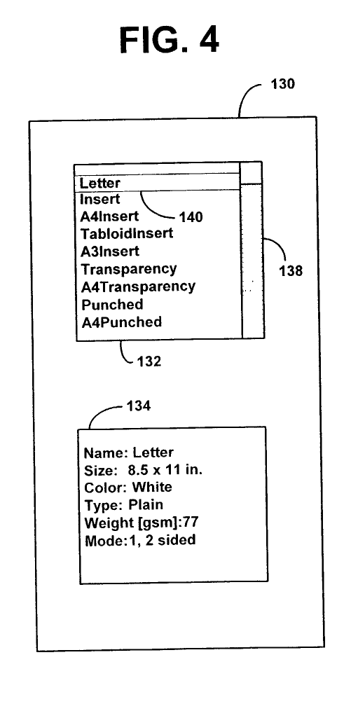

FIG. 4 is an illustrative screen 130 associated with the user interface 13 for showing a paper catalog. The user interface 13 may display a graphical representation of the paper catalog as the paper catalog screen 130 on the printing system 26 or the remote processing system 20. The paper catalog screen 130 includes a text window 132, which displays a selection of names of the media stored in the paper catalog. The text window 132 may include a scroll bar 138 to navigate through the list of media names in the paper catalog should the available media in the paper catalog be too numerous to display simultaneously. Using the keyboard or pointing device of the user interface 13, the user may select a media entry in the paper catalog by scrolling with the scroll bar 138 until the desired media is displayed in the text window 132, at which time the user selects the media by a keystroke or operation of the pointing device, such as a single click of a mouse, and the selected entry appears as a highlighted entry 140 on the user interface. The paper catalog screen 130 may also include a text box 134 that displays the attributes of the highlighted media entry 140.

It should be understood however, that displaying the paper catalog in a text window 132 is for illustrative purposes and the present invention is not restricted to the configuration illustrated in FIG. 4. For example, user interface 13 may display the paper catalog as a collection of icons, familiar to those of ordinary skill in the art. Each icon corresponds to media in the paper catalog. The icons may be grouped in an expandable tree and root configuration or independently selectable from a scrollable window as is familiar to those of ordinary skill in the art.

In one preferred embodiment of the invention, by operating on the highlighted entry 140 in paper catalog screen 130 through the user interface 13, e.g., by double clicking with the mouse or depressing the “Enter” key on the keyboard, the user may enable use of the paper catalog entry in the screen 101 of FIG. 3. For example, double clicking on the highlighted entry 140 on the paper catalog screen 130 may include the paper catalog entry to the medium indicator 102 of the screen 101 of FIG. 3. In contrast to having the complete paper catalog available to the user through the medium indicator 102, the medium indicator 102 may only display those media that have been selected from the paper catalog screen 130 by the method described above.

In such a manner, the user may construct a reduced paper catalog that lists the required media for the print job and excludes media that are not required for the print job. The reduced paper catalog is typically much smaller than the full paper catalog and facilitates associating the pages of the print job with media because searching the reduced paper catalog for a particular media is more efficient than searching the complete paper catalog.

In another presently preferred embodiment, the paper catalog screen includes another text window containing entries for the reduced paper catalog. FIG. 5 is another illustrative screen 146 associated with a user interface 13 for showing a paper catalog in accordance with the invention. The paper catalog screen 146 includes a text window 132, which displays a selection of names of the media stored in the paper catalog. The paper catalog screen 146 also includes a second text window 148 that is a graphical representation of the names of the media associated with the reduced paper catalog. In the illustrative example of FIG. 5, the reduced paper catalog includes two media entries corresponding to “TabB” and “Insert” media.

Selecting a media entry in the paper catalog and displaying the entry as a highlighted entry 140 in the text window 132 for the complete paper catalog, the user may add the selected media to the reduced paper catalog by operating on an active element of the user interface such as an “Add” button 150 provided by the user interface. Consequently, the highlighted entry 140 in the complete paper catalog also appears in the second text window 148 for the reduced paper catalog associated with the print job. Removing a media from the reduced paper catalog may include the steps of highlighting the entry to be removed in the second text window 148 and operating on a “Remove” button 152 provided by the user interface 13. In this manner, the user may construct a reduced paper catalog from the complete paper catalog.

The user may save the reduced paper catalogue by operating on the “Save” button 154 in the paper catalog screen 146 of the user interface 13. The saved reduced paper catalog may be associated with the print job by creating a header for the print job that instructs the printing system 26 on what media are used during the print run. Associating the reduced print catalog with the print job may alert the user to the type of media that must be loaded into the printer 18 in order to complete the print job. Also, by saving the reduced paper catalog with the print job, later printings of the print job do not require the operator to reconstruct the reduced paper catalog from the complete paper catalog.

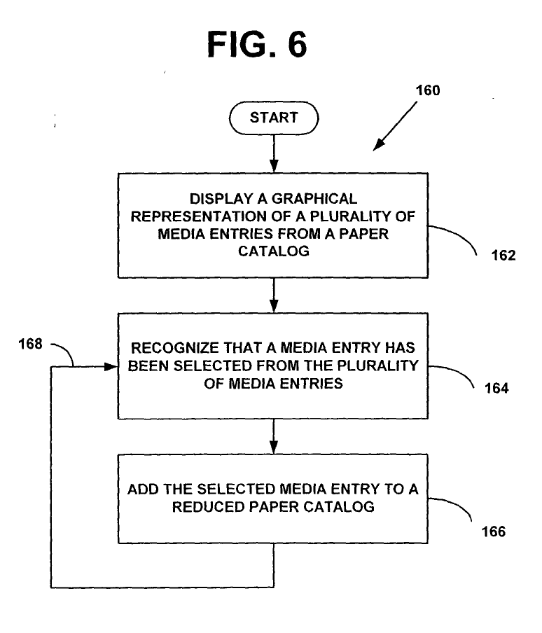

FIG. 6 is a flow diagram illustrating a preferred method 160 of selecting media for a print job on a user interface of the document production system 19 of FIG. 1. The method includes displaying a graphical representation 132 of a plurality of media entries from a paper catalog on the user interface 13 at step 162. The paper catalog corresponds to the media available for the print job. At step 164, the document production system 19 recognizes that a media entry 140 has been selected from the plurality of media entries on the user interface 13. At step 166, the document production system 19 adds the selected media entry 140 to a reduced paper catalog. The reduced paper catalog corresponds to the media used in the print job. The document production system 19 may repeat 168 steps 164 and 166 until the reduced paper catalogue is complete.

In yet another preferred embodiment of the invention, by selecting a media entry in the paper catalog and displaying the entry as a highlighted entry 140 in the text window 132 for the complete paper catalog, the user may add the selected media to the reduced paper catalog in the second text window 148 by dragging the highlighted entry 140 from the text window 132 and dropping it in the second text window 148. Dragging and dropping are operations in conjunction with pointing devices within user interfaces 13 that are familiar to those of ordinary skill in the art.

It should be understood however, that displaying the paper catalog in the text window 132 and second text window 148 are for illustrative purposes and the present invention is not restricted to the configuration illustrated in FIG. 5. For example, user interface 13 may display the complete paper catalog and/or the reduced paper catalog as a collection of icons in respective windows as is familiar to those of ordinary skill in the art. Each icon corresponds to media in the paper catalogs. The icons may be grouped in an expandable tree and root configuration or independently selectable from a scrollable window as is also familiar to those of ordinary skill in the art.

In a further preferred embodiment of the invention, the user may drag a highlighted entry for media from a text window 132 containing the paper catalog in such screens as illustrated in FIG. 4 or FIG. 5 and drop the dragged entry in a screen 101 such as that illustrated in FIG. 3. Dropping the highlighted entry in the screen 101 may provide an entry for the media in a pull-down menu associated with the medium indicator 102.

The foregoing detailed description is merely illustrative of several embodiments of the invention. Variations of the described embodiments may be encompassed within the purview of the claims. The steps of the flow diagrams may be taken in sequences other than those described, and more or fewer elements or components may be used in the block diagrams. Accordingly, any description of the embodiments in the specification should be used for general guidance, rather than to unduly restrict any broader descriptions of the elements in the following claims.

We claim:

1. A method of selecting media for a print job on a user interface of a document production system comprising:
(a) displaying a graphical representation of a plurality of media entries from a paper catalog on the user interface, wherein the paper catalog corresponds to the media available for the print job;
(b) recognizing that a media entry has been selected from the plurality of media entries on the user interface; and
(c) adding the selected media entry to a reduced paper catalog, wherein the reduced paper catalog corresponds to the media used in the print job.

2. A computer readable medium, having stored therein instructions for causing a central processing unit to execute the method of claim 1.

3. The method of claim 1 further comprising:
(d) displaying attributes associated with the selected media entry on the user interface.

4. The method of claim 1 further comprising:
(e) saving the reduced paper catalog with the print job on the document production system.

5. The method of claim 1 wherein step (b) comprises:
(b1) detecting a pointing device operation associated with a graphical representation of the selected media entry on the user interface.

6. The method of claim 5 further comprising:
(b2) detecting a keystroke associated with the selected media entry on the user interface.

7. The method of claim 1 wherein step (c) comprises:
(c1) detecting an active element operation of the user interface associated with the selected media entry on the user interface.

8. The method of claim 1 wherein step (c) comprises:
(c2) detecting a pointing device operation associated with a graphical representation of the selected media entry on the user interface.

9. The method of claim 8 wherein step (c2) comprises:
(c3) detecting dragging of the graphical representation of the selected media entry to a window on the user interface; and
(c4) detecting dropping of the graphical representation of the selected media entry in the window.

10. The method of claim 8 wherein step (c2) comprises:
(c5) detecting a double-click operation of the pointing device on the graphical representation of the selected media entry.

11. A method of selecting media for a print job on a document production system comprising:
(a) creating a reduced paper catalog from a paper catalog; and
(b) selecting the media for the print job from the reduced paper catalog.

12. The method of claim 11 wherein step (a) comprises:
(a1) selecting a graphical representation of a media entry from a plurality of media entries from a paper catalog on a user interface of the document production system;
(a2) dragging the selected graphical representation of the media entry to a graphical representation of the reduced paper catalog; and
(a3) dropping the selected graphical representation of the media entry into the graphical representation of the reduced paper catalog.

13. The method of claim 12 further comprising:
(a4) repeating steps (a1), (a2), and (a3) until the reduced paper catalog is complete.

14. The method of claim 11 wherein step (a) comprises:
(a5) selecting a graphical representation of a media entry from a plurality of media entries from a paper catalog on a user interface of the document production system; and
(a6) double-clicking the pointing device on the selected graphical representation of the media entry.

15. A system for selecting media for a print job on a user interface of a document production system comprising:
(a) means for displaying a graphical representation of a plurality of media entries from a paper catalog on the user interface, wherein the paper catalog corresponds to the media available for the print job;
(b) means for recognizing that a media entry has been selected from the plurality of media entries on the user interface; and
(c) means for adding the selected media entry to a reduced paper catalog, wherein the reduced paper catalog corresponds to the media used in the print job.

16. The system of claim 15 wherein (b) is selected from the group consisting of a computer pointing device and a keyboard.

17. The system of claim 15 wherein (c) comprises a computer pointing device.

18. A method of selecting media for a print job on a user interface of a document production system comprising:
(a) displaying a graphical representation of a plurality of media entries from a paper catalog on the user interface, wherein the paper catalog corresponds to the media available for the print job;
(b) detecting a pointing device operation associated with a graphical representation of a media entry on the user interface to select the media entry from the plurality of media entries; and
(c) detecting a pointing device operation associated with a graphical representation of the selected media entry on the user interface to add the selected media entry to a reduced paper catalog, wherein the reduced paper catalog corresponds to the media used in the print job.

19. A computer readable medium, having stored therein instructions for causing a central processing unit to execute the method of claim 18.
